(19) United States
(12) Patent Application Publication
(10) Pub. No.: US 2012/0166285 A1
(43) Pub. Date: Jun. 28, 2012

(54) Defining and Verifying the Accuracy of Explicit Target Clusters in a Social Networking System

(76) Inventors: Scott Shapiro, (US); Meg Griffing Sloan, (US); Richard Sim, (US)

(21) Appl. No.: 12/980,176

(22) Filed: Dec. 28, 2010

(51) Int. Cl. G06Q 30/00

(52) U.S. Cl. 705/14.58; 705/14.49; 705/14.66

(57) ABSTRACT

A cluster of users that share a common trait may be useful to a social networking system for various purposes, such as targeting advertising. Users of a social networking system are added to a cluster based on information about each user, which may include declared profile information, user history, and/or social information. The system initially adds users to a cluster based on a selected attribute and then verifies the accuracy of the cluster by sending a poll to a subset of the users in the cluster. The poll questions test whether the users are accurately in the cluster. The system may infer a specific life event, such as a recent engagement, from other information indicative of the life event, such as messages from a user's connections related to the engagement. The system then uses the poll to verify whether the inference is accurate.

### BACKGROUND

This invention relates generally to social networking, and in particular to defining and maintaining clusters of users in a social networking system for targeting advertisements.

Traditional targeting criteria for advertising relies on demographic data and structured information, such as a user's self-declared interests and intentions to be marketable, i.e., to be in the market to purchase a product or service. Advertisers, in an effort to locate and target these users purchase analytical data gathered by third parties that track users visiting websites related to the advertiser's product. For example, websites on the Internet track people comparing car prices and filling out a form for a test drive at a local dealership and sell this information to advertisers. Advertisers may also target specific types of publishers or pages within a publisher's network in an effort to reach their intended audience (e.g., ads on Cars.com or the cars category on Yahoo to reach users who are believed to be in the market to buy a car.) But in the end, advertisers are limited to educated guessing at a user's intent to purchase or a user's interest in a particular subject matter.

In recent years, users of social networking systems have shared their interests and engaged with other users of the social networking systems by sharing photos, real-time status updates, and playing social games. The amount of information gathered from users is staggering—information describing recent moves to a new city, graduations, births, engagements, marriages, and the like. Social networking systems have been passively recording this information as part of the user experience, but social networking systems have lacked robust tools to use this information about users for targeting advertisements.

Specifically, the information available on social networking systems has not been used to define clusters of users of a social networking system that are in the market for a specific product, such as a new car. Social networking systems have not provided advertisers with highly accurate groups of users that have been categorized by shared attributes, such as recent college graduates that have found employment.

### SUMMARY

Embodiments of the invention identify and evaluate clusters of users of a social networking system, where a cluster is a group of users who have one or more common traits. Once constructed, a cluster may be used for various purposes, such as advertisement targeting to members of the cluster. In one embodiment, users of a social networking system are added to a cluster based on information about each user, which may include declared profile information, user history or activity information, and/or social information (i.e., information about a user's connections in the social networking system). After the system adds users to a cluster based on one or more attributes, it then verifies the accuracy of the cluster by sending a poll to a subset of the users in the cluster. The poll questions test whether the users are accurately classified as a member in the cluster (e.g., “Did you get engaged within the last 3 months?”), in contrast to performance testing that test whether members of the cluster are actually interested in an advertised product or service (e.g., “Are you shopping for rings?”). This accuracy testing enables the system to have a higher level of certainty that the cluster's membership is accurate.

In addition to the accuracy testing, performance testing may be performed (e.g., measuring click-through rates of members in the cluster for a particular advertisement). This can be done with live ads or using historical ads that have targeted users in the cluster. For example, embodiments of the invention may identify a group of ads that have attempted to target users who are interested in NFL football. By comparing the CTR of the users in the NFL cluster who have seen the ad, the users' historical click through rates for all ads, and the click through rate of all users exposed to that ad, the embodiments can determine if the cluster is in fact accurately constructed. In another embodiment, the accuracy of the cluster is tested by comparing poll results of that cluster versus the poll results of the general population. For example, to test how well the system has captured a cluster of users who are interested in NFL football, the system may poll both the cluster and the general population and determine how much more the polled group of users are interested in NFL than the general population.

In one embodiment, the system may infer a specific life event, such as a recent engagement, from other information indicative of the life event, such as messages from a user's connections related to the engagement. The system may use an accuracy testing poll to verify whether the inference is accurate by polling users who have been added to the cluster and/or their connections. The poll questions may test accuracy by directly by asking the user to confirm the attribute. Alternatively, the poll questions may test the accuracy of a user's inclusion in a cluster indirectly (e.g., rather than ask whether a user's friend was recently married, the system may ask whether the user recently attended a wedding).

### BRIEF DESCRIPTION OF THE DRAWINGS

FIG. 1 is high level block diagram illustrating a process of defining clusters based on an attribute of users of a social networking system and verifying the accuracy and performance of the defined clusters, in accordance with an embodiment of the invention.

FIG. 2 is a network diagram of a system for defining clusters based on a selected attribute of users of a social networking system and verifying the accuracy and performance of the defined clusters, showing a block diagram of the social networking system, in accordance with an embodiment of the invention.

FIG. 3 is high level block diagram illustrating a cluster accuracy module that includes various modules for verifying whether users have been accurately added to a cluster, in accordance with an embodiment of the invention.

FIG. 4 is a flowchart diagram depicting a process of defining clusters based on an attribute of users of a social networking system and verifying the accuracy and performance of the defined clusters, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. The social networking system may also utilize user profile information to direct advertisements to the user, ensuring that only relevant advertisements are directed to the user. Relevant advertisements ensure that advertising spending reaches their intended audiences, rather than wasting shrinking resources on users that are likely to ignore the advertisement.

In addition to declarative information provided by users, social networking systems may also record users' actions on the social networking system. These actions include communications with other users, sharing photos, interactions with applications that operate on the social networking system, such as a social gaming application, responding to a poll, adding an interest, and joining an employee network. Information about users, such as stronger interests in particular users and applications than others based on their behavior, can be generated from these recorded actions through analysis and machine learning by the social networking system.

A social networking system may also attempt to infer information about its users. A social networking system may analyze large bursts of comments on a user's wall or status update from other users that include keywords such as “Congratulations” and “baby.” Though largely unstructured, this information can be analyzed to infer life events that are happening to users on the social networking system.

Further, user profile information for a user is often not complete and may not even be completely accurate. Sometimes users deliberately provide incorrect information; for example, a user may provide incorrect age in the user profile. Users may also forget to update their information when it changes. For example, a user may move to a new location and forget to update the user's geographical location, or a user may change jobs but forget to update their workplace description in the user profile. As a result, a social networking system may infer certain profile attributes of a user, such as geographic location, educational institutions attended, and age range, by analyzing the user's connections and their declared profile information. Inferring profile attributes are further discussed in a related application, “Inferring User Profile Attributes from Social Information,” U.S. application Ser. No. 12/916,322, filed Oct. 29, 2010, which is incorporated by reference in its entirety.

Even though a social networking system may collect, and in some cases infer, information about its users, significant resources must be expended to organize the staggering amounts of data collected. A social networking system having over 500 million users, for example, gathers and infers a staggering amount of information about its users. To address issues of scalability and efficiently expending computing resources, a social networking system provides a snapshot of databases for modules to process. Recent changes in a user's personal life, such as an engagement, birth of a child, moving across the country, graduating from college, and starting a new job, can be collected and inferred from these snapshots on social networking systems.

Reliable information about these life events is very valuable to advertisers because these users are more influenced by targeted advertisements. For example, users who recently changed their relationship status on a social networking system within the past three months are more susceptible to clicking on an advertisement for a local wedding venue because they are still in the market for a wedding venue. Users who have been engaged for more than three months might have already booked a wedding venue, making the information about their engagement stale and less valuable to advertisers. The potential value of clustering users based on information about users' life events depends heavily on the accuracy of the clustering.

Some users may engage in “profile fraud,” deliberately making false statements about themselves and other users on the social networking system. Some users may change their relationship status to “engaged” even though, in reality, the users are not actually engaged. (For example, it is common practice for high school students to indicate that they are married to each other or married to social activities like volleyball or school.) Other users may indicate a sibling or parent-child relationship in the same manner. Accordingly, in order to provide reliable clusters of users, a social networking system needs to authenticate potential advertising clusters for accuracy to identify and exclude these fraudulent users. Machine learning, heuristics analysis, and regression analysis may be utilized in authenticating the clusters.

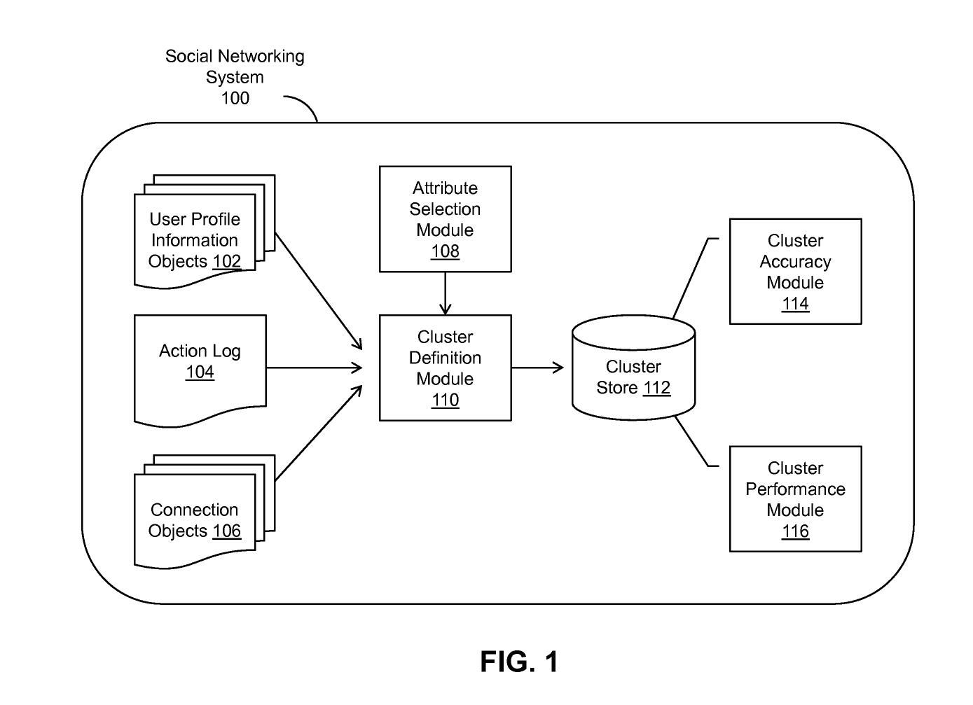

FIG. 1 illustrates a high level block diagram of a process for defining clusters based on an attribute of users of a social networking system and verifying the accuracy and performance of the defined clusters, in one embodiment. The social networking system 100 includes user profile information objects 102, an action log 104, and connection objects 106. Each user of the social networking system 100 is associated with a specific user profile information object 102. These user profile information objects 102 include declarative information shared by the user as well as any profile information inferred by the social networking system 100. In one embodiment, a user profile information object 102 may include thirty different data fields, each data field describing an attribute of the corresponding user of the social networking system 100.

Users of the social networking system 100 may take actions using the social networking system 100 that are associated with one or more objects. Information describing these actions is stored in the action log 104. The action log 104 includes many different types of interactions that occur on a social networking system, including commenting on a photo album, communications between users, becoming a fan of a musician, and adding an event to a calendar. Additionally, the action log 104 records a user's interactions with advertisements on the social networking system 100 as well as other applications operating on the social networking system 100.

Connection objects 106 store information about users' connections on a social networking system 100. Such information may include the interactions between the user and the connection on the social networking system 100, including wall posts, comments on photos, geographic places where they have been tagged together, and photos in which they have both been tagged in. In one embodiment, a connection object 106 includes information about the strength of the connection between the users, such as an affinity score. If a user has a high affinity score for a particular connection, the social networking system 100 has recognized that the user interacts highly with that connection.

A social networking system 100 may define clusters of users based on desired attributes of the users using a cluster definition module 110. These attributes may be predefined by the social networking system 100 or may be specifically requested by an advertiser. A cluster definition module 110 receives a selection of at least one attribute from an attribute selection module 108. The cluster definition module 110 selects users based on data gathered from user profile information objects 102, the action log 104, and connection objects 106 that indicate the users may have the selected attribute.

To illustrate the general process of defining a cluster of users based on a selected attribute, as an example, a cluster may be defined as users who have changed their relationship status to “engaged” in the past three months. An advertiser may select these parameters, engaged users within the past three months, using the attribute selection module 108 to generate clusters in real-time, in one embodiment. In another embodiment, attributes for specific clusters are pre-selected by the social networking system 100. In this example, the cluster definition module 110 selects user profile information objects 102 based on an analysis of snapshots of the user profile information objects 102 that determines whether a data field has changed to “engaged” from any other status.

Similarly, selections of other attributes are provided to the cluster definition module 110 to define other types of clusters. For example, an advertiser may desire to select users on the social networking system having a specific ethnic background, such as U.S. Hispanic users. The cluster definition module 110 may be provided with a listing of Hispanic last names and select users that have matching last names in the data field for last names in user profile information objects 102. In another embodiment, this cluster may be built by analyzing the network of friends that a user has and set a threshold for friends who reside in Spanish speaking countries. If that threshold were set to 10%, for example, the system would populate the cluster based on people had more than 10% of their friends living in Spanish speaking countries. This threshold may be set based on some iteration and polling for accuracy. As another example, users that have recently changed their location or have been verifying in at places in a new geographic location may be added to a cluster of users that are new to a particular city. The cluster definition module 110 may also define clusters using pre-selected attributes by administrators of the social networking system 100.

Once a cluster is defined, it is stored in a cluster store 112. Before advertisements are targeted towards a newly defined cluster of users on the social networking system 100, the accuracy of the cluster is checked using the cluster accuracy module 114. Various methods of accuracy verifying can be used, including polling a sample of users in the cluster regarding the truthfulness of the selected attribute (e.g., “Did you just get engaged?”), polling connections of users regarding the selected attribute (e.g., “Which of your friends a recently engaged?”), and analyzing published content on the social networking system 100 associated with users in the cluster to determine whether the attribute is accurate. Other indirect ways of polling for accuracy include analyzing the historical CTR for ads that were shown to this cluster of users. For example, for the Hispanics cluster, the system could look for historical ads that had content relevant to this cluster and then analyze the CTR of these users for that ad versus the CTR for the ad in general. The system could also compare with the CTR of those users in general, assuming that the CTR of the users in the cluster who saw those ads would be higher than all users who saw that ad and that the CTR for users in the cluster so saw those ads would be higher than the average CTR for those users. This ability to explicitly interact with users on the social networking system 100 ensures that the cluster can be thoroughly checked for accuracy.

Other methods of cluster accuracy analysis performed by the cluster accuracy module 114 include heuristics analysis to identify false positives and analyze unstructured data as well as regression analysis to determine cluster accuracy based on multiple predictive factors. For example, a cluster may include a user that has fraudulently indicated that another user is his parent. Heuristics analysis may be utilized to identify this user by calculating the age difference between the declared parent and child and flagging the user if the difference is less than 14 years. Additionally, the heuristics algorithm may check the last names of the users for a match and whether the users have similarities using facial recognition software that compares photos of the users.

Regression analysis may be used to identify the predictive factors that should be relied upon in testing the accuracy of a cluster. Additionally, scoring algorithms may be implemented using regression analysis to determine the accuracy of a cluster. Predictive factors may be selected by administrators of the social networking system. For example, users that recently graduated from college may have indicated on their profile information the year of their graduation, may have uploaded pictures that include graduation gowns as recognized by image recognition software, may have received a large burst of communications that included the word “congratulations,” and so on.

Additionally, the cluster accuracy module 114 can compute an accuracy measurement, or confidence metric, in response to the polling. For example, the cluster accuracy module 114 may determine, based on the responses of polling questions, that the cluster is 95% accurate because only 5% of the polled users responded that they did not possess the selected attribute. A social networking system 100 may utilize, in one embodiment, a threshold system in which clusters must meet a predefined percentage of accuracy before the cluster is tested for performance. Clusters that fail to meet the threshold may be flagged for manual review by administrators of the social networking system 100 or may automatically be processed by the cluster definition module 110 to narrow the search query of users to exclude inaccurately clustered users.

After a cluster is checked for accuracy, the cluster is ready for performance testing by the cluster performance module 116. The cluster of users is targeted with advertisements based on their shared attribute. The cluster performance module 116 then measures the conversion rates, click-through rates (CTRs), percentage of budget spent, cost per click, impressions, and brand awareness of the advertisements, depending on the intended purpose of the advertisements. The performance metrics of a cluster help to validate the proposition that these clusters outperform traditional targeting criteria. Returning to the example above, a 95% accurate cluster of users may outperform a traditional demographic group of users by 25% in comparing click-through rates. The cluster performance module 116 provides a social networking system 100 with additional confidence that the clusters are accurate and worth the added premium in terms of pricing and implementation time to advertisers. Not all clusters need have premium pricing associated with them, and some may be made available to all advertisers via a self serve ad manager system. Additionally, performance metrics may be monitored over time to track advertising campaigns and provide additional information to advertisers.

### System Architecture

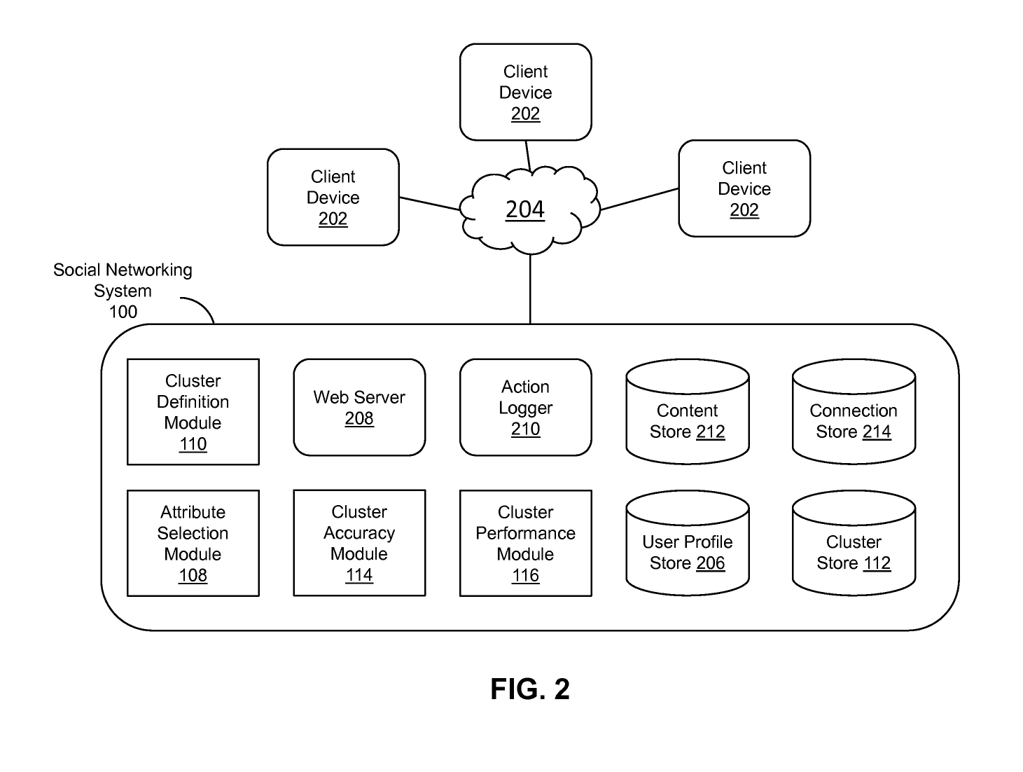

FIG. 2 is a high level block diagram illustrating a system environment suitable for inferring information describing users based on social networking information, in accordance with an embodiment of the invention. The system environment comprises one or more client devices 202, the social networking system 100, and a network 204. In alternative configurations, different and/or additional modules can be included in the system.

The client devices 202 comprise one or more computing devices that can receive user input and can transmit and receive data via the network 204. In one embodiment, the client device 202 is a conventional computer system executing, for example, a Microsoft Windows-compatible operating system (OS), Apple OS X, and/or a Linux distribution. In another embodiment, the client device 202 can be a device having computer functionality, such as a personal digital assistant (PDA), mobile telephone, smart-phone, etc. The client device 202 is configured to communicate via network 204. The client device 202 can execute an application, for example, a browser application that allows a user of the client device 202 to interact with the social networking system 100. In another embodiment, the client device 202 interacts with the social networking system 100 through an application programming interface (API) that runs on the native operating system of the client device 202, such as iOS 4 and DROID.

In one embodiment, the network 204 uses standard communications technologies and/or protocols. Thus, the network 204 can include links using technologies such as Ethernet, 802.11, worldwide interoperability for microwave access (WiMAX), 3G, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 206, a web server 208, an action logger 210, a content store 212, a connection store 214, a cluster store 112, a cluster definition module 110, a cluster accuracy module 114, a cluster performance module 116, and an attribute selection module 108. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more client devices 202; the web server 208 serves web pages, as well as other web-related content, such as Java, Flash, XML, and so forth. The web server 208 may provide the functionality of receiving and routing messages between the social networking system 100 and the client devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native client device operating systems, such as iOS, DROID, webOS, and RIM.

Clusters for targeting users of the social networking system 100 are defined by the cluster definition module 110 after at least one shared attribute is selected through the attribute selection module 108. The attribute may be selected by an advertiser in real time or may be pre-selected by the social networking system 100. The clusters are stored as objects in the cluster store 112 to be later used to target advertisements to users of the social networking system 100. The cluster store 112 maintains these objects in the social networking system 100. The cluster accuracy module 114 performs accuracy verifies on the clusters stored in the cluster store 112. The cluster performance module 116 measures the performance of these clusters by analyzing user actions on advertisements that have been served to the clusters of users by the web server 208. User actions on the social networking system 100 are recorded by the action logger 210.

The action logger 210 is capable of receiving communications from the web server 208 about user actions on and/or off the social networking system 100. The action logger 210 populates the action log 104 with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

User account information and other related information for a user are stored in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. A user profile store 206 maintains profile information about users of the social networking system 100, such as age, gender, interests, geographic location, email addresses, credit card information, and other personalized information. The user profile store 206 also maintains references to the actions stored in the action log 104 and performed on objects in the content store 212.

Although the system has access to the users' personal information, contained in the user profile store 206, the system preferably protects the users' information. For example, embodiments of the invention never include any personally identifiable information with the clusters. For example, even if email addresses were stored in the user profile store 206, the system may not build a cluster of users using their email address. In one embodiment, the system may build a cluster of users who have active credits tied to a credit card. Accordingly, while the system would avoid associating personally identifiable information with an individual user, it may aggregate this information at the cluster level.

The connection store 214 stores the information describing the connections between users. The connections are defined by users, allowing users to specify their relationships with other users. For example, the connections allow users to generate relationships with other users that parallel the users' real-life relationships, such as friends, co-workers, partners, and so forth. In some embodiment, the connection specifies a connection type based on the type of relationship, for example, family, or friend, or colleague. Users may select from predefined types of connections, or define their own connection types as needed. The connection store 214 acts as a cross-referencing database for the user profile store 206 and the content store 212 to determine which objects are also being modified by connections of a user. Embodiments of the invention may also infer the relationship between two users (e.g., using an affinity algorithm) and use that for cluster building (e.g., by building a cluster of users whose close friends have upcoming birthdays next week, in which case the close friend would be identified using the coefficient value).

The cluster accuracy module 114 communicates directly with users of the social networking system through the network 204 and client devices 202 when polling about the accuracy of clusters. A poll question may be communicated using a pop-up window, a message to the user, and as an advertisement on the social networking system 100 as displayed on a client device 202. Responses to poll questions are received by the cluster accuracy module 114 through the network 204 and client devices 202.

### Creation and Verifying the Accuracy of Explicit Target Clusters

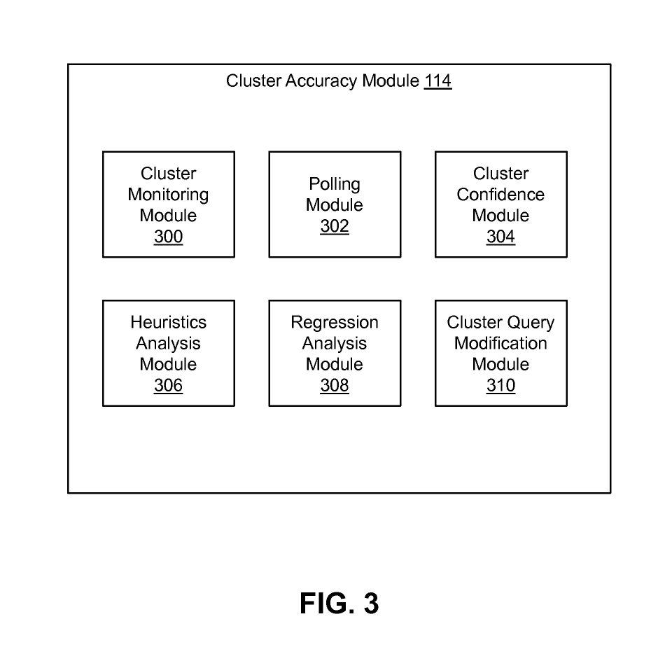

FIG. 3 illustrates a high level block diagram of the cluster accuracy module 114 in further detail, in one embodiment. The cluster accuracy module 114 includes a cluster monitoring module 300, a polling module 302, a cluster confidence module 304, a heuristics analysis module 306, a regression analysis module 308, and a cluster query modification module 310. These modules may perform in conjunction with each other or independently to verify the accuracy of a defined cluster.

A polling module 302 verifies the accuracy of a cluster by polling a sample of the users associated with the cluster. In one embodiment, the polling module 302 polls a sample of the users in the cluster and determines, from the responses of the sampled users, an accuracy measurement of the cluster. For example, a user may be asked, within the social networking system 100, whether the shared attribute is accurate, such as “Did you recently become engaged?” and “Did you recently change jobs?” The responses to this explicit polling of a sampling of users in the cluster can be used by the cluster confidence module 304 to determine an accuracy measurement of the cluster. The polling module 302 may also poll other users connected to the users in the cluster being checked to determine the accuracy of the cluster. The polling module 302 includes instructions to instigate a poll among users of the social networking system 100 and a way for administrators to pose specific poll questions for different types of attributes of clusters.

The cluster confidence module 304 determines an accuracy measurement for each cluster in the cluster store 112. A cluster can be measured for how accurately the cluster definition module 110 defined the cluster to include users that share a selected attribute. The accuracy measurement may be determined using a variety of methods. In one embodiment, the accuracy of a cluster is determined by polling a sample of the users in the cluster and using the percentage of the polled users that confirmed the accuracy of the selected attribute as the accuracy measurement. For example, if 95% of the polled users responded “Yes” to the polling question, “Have you gotten engaged in the past three months?”, then the accuracy measurement returned by the cluster confidence module 304 would be 0.95, assuming that the accuracy measurement is a real number between 0 and 1. In one embodiment, the system normalizes this information to remove an opt-in bias of the users.

Another way to determine an accuracy measurement for a cluster is to use social networking system information to corroborate the selected attribute. Such information may include responses to polling questions targeted at the users' connections on the social networking system, bursts of communications and activity associated with the users in the cluster, and actions performed on the social networking system by the users such as checking into a specific location and attending events with a specific location. Continuing with the example above, connections of the users in the cluster may be polled with the question, “Which of these people are recently engaged?” and the percentage of responses confirming the engagement is used as the accuracy measurement. In one embodiment, the questions are asked without using real names. For example: “Which of the following has visited Mexico in the past year? Myself, my brother, my sister, or my mother?”

Unstructured information on the social networking system, gathered from user profile information objects 102, the action log 104, and connection objects 106, can be analyzed and scored by the cluster confidence module 304. Bursts of activity related to users of a cluster, for example, can be detected by the social networking system 100 and identified. For example, it may be expected that a cluster of users defined as “recently engaged” may have a burst of communications that include keywords such as “Congratulations” and “engagement” from other users. This expectation may be measured by normatively scoring these bursts of activity based on past empirical data measuring such bursts of activity on the social networking system. A specific normative threshold of expected activity may be generated for pre-selected life events, or attributes, such as recent engagements. If a user in the cluster had received more than the predefined threshold, then the accuracy measurement for that user would be 100%, or a score of 1. Other types of unstructured information can be similarly measured and scored, including image recognition of wedding photos, recognizing multiple check-ins at or around a particular geographic location, mining keywords in a user's status updates, and a significant increase in the number of new friend requests, or new connections, from users in a different geographic location than the one indicated in the user's profile.

In another embodiment, the cluster accuracy measurement may be determined by the cluster confidence module 304 by using a combination of the techniques discussed above and building a regression model that assigns a certain weight to each of the tests. Using a regression analysis module 308, the regression model would return a score that indicates whether a user is a good fit with existing empirical data of verified accurate users in the cluster. A curve fit, or best fit, yields a number from 0 to 1 that can be used as the accuracy measurement of the cluster by the cluster confidence module 304, in one embodiment. The regression analysis module 308, in one embodiment, adapts the regression model to include or exclude factors that are determined to be relevant or not relevant to the verifying the accuracy of clusters based on machine learning and in response to polling.

A heuristics analysis module 306 operates independently and asynchronously from the other modules in the cluster accuracy module 114. The heuristics analysis module 306 performs various steps to gather information from the social networking system 100. For example, the action log 104 includes actions that users perform on the social networking system. The heuristics analysis module 306 may be used to analyze the level of communications activity for particular users and determine whether those communications included keywords, as described above. Another use of the heuristics analysis module 306 includes gathering and analyzing different types of information about a user's geographic location such as check-ins at places in a specific geographic area, attending events in the same geographic area, receiving requests for connecting with users from the same geographic area, and geo-location codes embedded in photos and other communications, such as text messages, uploaded to the social networking system by the user.

The heuristics analysis module 306 also determines the various locations of the connections of the user to infer the location of a user based on a subset of the connections of the user that interact frequently with the user. Interactions between users and their connection include exchanges of messages, wall posts, comments made on photos or videos, recommendations made to other users, and the like. Users that have not interacted with the user for a long time can be excluded since there is a possibility that they are old connections of the user and the user may have moved to a different location. The locations of the subset of the connections of the user are analyzed to determine the number of connections at each location. The location of the user is inferred as the location with the highest number of connections of the user that frequently interact with the user. For example, if a large number of users that the user frequently interacts with belong to a city, the user may be inferred to be residing in that city. If the users that the use interacts with belong to different cities all belonging to the same country, that country can be inferred as the user's country.

The location of a user can be determined based on other factors, for example, based on the internet protocol (IP) address associated with sessions created by the user. Various communication protocols provide IP address of a client device used to establish communication with a server in the social networking system 100. The IP address of the client device can be mapped to geographical location of the machines using the IP address. As a result, the geographical location of the client device can be determined. Some client devices are equipped with global positioning systems (GPS) and the location of the client device as provided by GPS may be available to the social networking system 100. The location of a client device 205 that is equipped with wireless communication functionality may be obtained from the cell towers that the client device interacts with. Another factor used to infer the location of a user is the locale of the user used to interact with the social networking system 100. For example, a user using French locale is likely to be located in France (subject to information inferred from other sources). The location of a user can also be provided by the user in the user profile.

In an embodiment, conflicts in locations obtained from various sources are resolved by attaching a confidence score with the source, for example, the location obtained via GPS may be considered more reliable compared to location specified by the user. The confidence score of the inferred values from various sources is compared to determine a final inferred location of the user as well as the confidence score of the inferred location. In one embodiment, a heuristics engine utilizes the confidence score of the inferred location of users to determine an accuracy measurement of the cluster.

A cluster query modification module 310 may be used in the cluster accuracy module 114 to redefine the query that created a cluster. This cluster query modification module 310 may add computer instructions to the original query that, for example, excludes false positives that have been detected as a result of the polling module 302, the cluster confidence module 304, the heuristics analysis module 306, and the regression analysis module 308. The cluster query modification module 310 may also modify a query to include or exclude sources of information that were used to define the cluster. For example, if the size of the cluster was not large enough to present to advertisers, additional users could be included in the cluster and the cluster could be checked for accuracy. Because the pricing of advertising could be correlated to the accuracy of the cluster, the cluster query modification module 310 could be used expand or reduce the number of users in a cluster in this manner.

A cluster monitoring module 300 performs asynchronously on the clusters stored in the cluster store 112. The cluster monitoring module 300 gauges the accuracy of individual clusters and determines whether the cluster meets a predefined threshold, in one embodiment. If a cluster fails to meet the threshold, then the cluster is flagged in the cluster store 112 for manual review. In another embodiment, a cluster that fails to meet the threshold is automatically redefined by the cluster query modification module 310. The cluster monitoring module 300 may also periodically check the accuracy of clusters stored in the cluster 112 to ensure the accuracy measurements are up to date.

In one embodiment, the cluster monitoring module 300 performs ongoing maintenance on the clusters to maintain their quality. This may be performed by suggesting new attributes to use for a cluster while also suggesting ways to prune outdated/irrelevant attributes for a cluster. For example, for a “Fashion Interests” cluster, the cluster monitoring module 300 may use various techniques to keep the cluster current and fresh with the changing fashion terms. One way to do this is to use a machine learning system to determine other keywords that are commonly associated with keywords in the given cluster. For example, if Gucci, Prada, and other designers are in this cluster, the cluster monitoring module 300 may look for patterns where other keywords, based on their co-occurrence in status updates or pages, are suggested for the cluster. Alternatively, the cluster monitoring module 300 may prune keywords by looking at the poorest performing users in historical ads and determining which data attribute was used to include those users into the cluster. If many users who were included into the “Recently Married” cluster were under the age of 18 and had low CTR, the cluster monitoring module 300 may suggest that data attribute to be removed from the system. This could be further monitored and managed by a human to make these add/delete decisions.

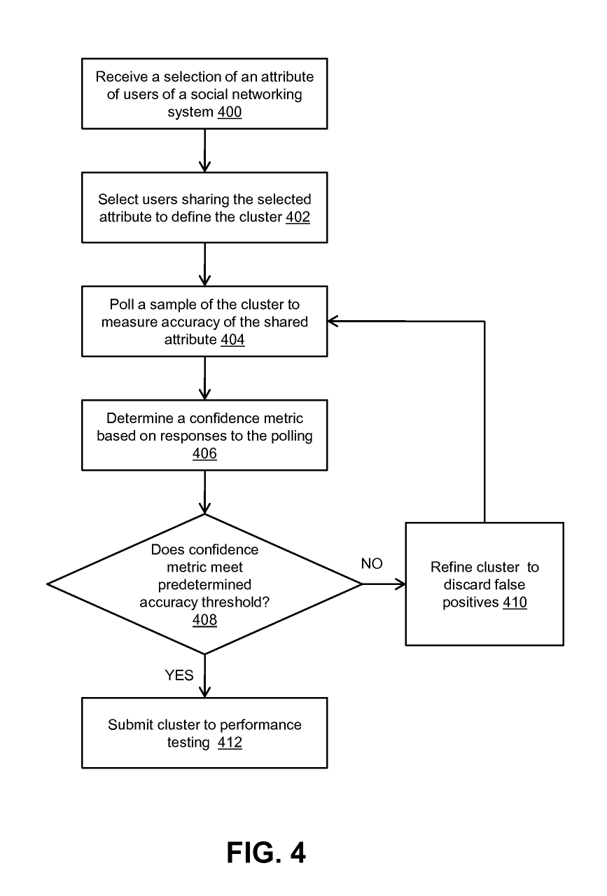

FIG. 4 illustrates a flow chart diagram depicting a process of defining clusters based on an attribute of users of a social networking system, verifying the accuracy of the clusters and submitting clusters to performance testing. An attribute of users of a social networking system is received 400 in order to define a cluster. Such an attribute may include recently engaged users, recently married users, users that are expecting a new baby, users that have teenage children, users that are stay at home mothers, users that include reality television shows in their status updates, and the like.

Several attributes can be selected to create a cluster of multiple sub-clusters. For example, a cluster may include a sub-cluster of newly married users and a sub-cluster of users who recently moved to a suburb of a major city. Advertisers may wish to market a product, such as maid service, to newly married users and users who have recently moved to a suburb. The accuracy of these sub-clusters is checked independently, and the average of the accuracy measurements for the sub-clusters is used for the accuracy measurement of the cluster.

Once the attribute is received 400, users sharing the received attribute are selected 402 to define the cluster using at least one query from at least one database on the social networking system 100. An administrator may set up query templates that can be customized to select different types of users. The selection query can be automatically populated with query instructions, based on the received attribute, to identify users from various sources of data, including the actions performed on the social networking system 100 that have been recorded in the action log 104, recent database snapshots showing changes in user profile information objects 102 (such as relationship status and location), and databases that have been created to identify users associated with unstructured data events that indicate the presence of the selected attribute in a user. Such unstructured data events may include a large number of recent communications including a keyword such as “Congratulations,” being tagged by several users in separate photo albums that includes the word “wedding” in the album title, and identifying a photo of the user in a wedding dress or tuxedo, as recognized by image recognition software, that is displayed as the user profile picture. As mentioned above, a heuristics analysis module 306 may perform these actions to create a database of users that may be identified as being recently married through these steps, in one embodiment.

After the cluster has been defined by selecting 402 users that share the selected attribute, a sample of users associated with the cluster is polled 404 to measure the accuracy of the shared attribute. In one embodiment, a sample of the users in the cluster is polled 404 with a question regarding the accuracy of the shared attribute. In another embodiment, users that are connected to a sample of the users in the cluster are polled 404 with a question regarding the shared attribute. In yet another embodiment, a sample of the users in the cluster is polled with other questions that are indirectly related to whether the shared attribute is accurate. The polling module 302 in the cluster accuracy module 114 performs this polling step 404.

After a sample of users associated with the cluster has been polled 404, an accuracy measurement is determined 406 for the cluster based on the responses to the polling. The accuracy measurement can be determined by calculating the percentage of users confirming the shared attribute in their responses to the polling. The cluster accuracy module 114 described above performs this determining step 406.

In one embodiment, the determined accuracy measurement is tested 408 against a predetermined accuracy threshold. If the accuracy measurement does not satisfy the threshold, then the cluster is refined 410 to discard false positives. The cluster is refined 410 using a variety of methods, including manually removing false positives, modifying the query that was used to define the clusters to include or exclude users using automated and manual techniques, analyzing unstructured data events using heuristics analysis to identify false positives, and other techniques described above. The refined cluster is then polled 404 to determine a new accuracy measurement.

If the accuracy measurement satisfies the threshold, then the cluster is submitted 412 to performance testing. The cluster of users is presented with real advertisements and the click through rates, conversion rates, and brand awareness are measured against a control group of users presented with the same advertisements. Performance testing helps verify the value proposition to potential advertisers by showing the improvement in performance between these clusters and traditional demographic targeting of users. This performance testing is executed by the performance module 116 described above. As illustrated in FIG. 4, clusters can be refined based on an accuracy measurement threshold. The process of determining accuracy measurements of clusters informs advertisers and provides a basis for different levels of pricing. Cluster monitoring may also be performed to ensure the accuracy of clusters is up to date.

### Cluster Definition Based on Behavioral Attributes of Users

In addition to static attributes that are selected by advertisers or pre-selected by the social networking system, clusters may also be defined by the level of engagement and usage of the social networking system. For example, users that recommend news articles, restaurants, local businesses, gadgets, and the like, also known as “recommenders,” may be clustered by analyzing their behavioral patterns on the social networking system. Users may further be classified as “recommenders” based on the size of their social network, the update frequency of the user's account, and other information related to the user's ability and tendency to influence other users. Advertisers highly value these types of users because they are more likely to recommend products and deals to their connections. A separate data field may be added to user profile information objects to flag these types of users.

Users of certain applications that perform on the social networking system may also be defined as a cluster. For example, advertisers of a new social gaming application may request to advertise to users that have installed and engaged with a similar social gaming application. Even more, advertisers may want to isolate users that have interacted with a specific application over a predetermined threshold of usage in the past month, for example. A cluster of users satisfying these attributes may be defined and checked for accuracy using the methods described above.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for defining clusters based on an attribute of users of a social networking system, the method comprising:
receiving a selection of an attribute shared by a subset of users of a social networking system;
determining a cluster as the subset of users sharing the selected attribute;
verifying users of the social networking system related to the cluster;
determining an accuracy measurement of the cluster based upon the verifying; and
providing the cluster and the accuracy measurement for performance testing.

2. The method of claim 1, wherein determining a cluster as the subset of users sharing the selected attribute comprises adding users to the cluster based on profile information relating to the selected attribute.

3. The method of claim 1, wherein determining a cluster as the subset of users sharing the selected attribute comprises adding users to the cluster based on content information including a keyword related to the selected attribute.

4. The method of claim 1, wherein determining a cluster as the subset of users sharing the selected attribute comprises adding users to the cluster based on an inference related to the selected attribute.

5. The method of claim 4, wherein adding users to the cluster based on an inference related to the selected attribute comprises adding an inferred user based on retrieved profile information of users connected to the inferred user.

6. The method of claim 1, wherein verifying users of the social networking system related to the cluster comprises questioning a sampling of users in the cluster regarding the veracity of the selected attribute.

7. The method of claim 1, wherein verifying users of the social networking system related to the cluster comprises questioning users connected to a sampling of users in the cluster regarding the veracity of the selected attribute.

8. The method of claim 1, wherein verifying users of the social networking system related to the cluster comprises performing heuristic methods to determine the veracity of the selected attribute.

9. The method of claim 8, wherein the selected attribute relates to a specific geographic location, and performing heuristic methods to determine the veracity of the selected attribute comprises:
comparing the geographic location of a sampling of users in the cluster and the specific geographic location related to the selected attribute, and
determining the veracity of the selected attribute based upon the comparison.

10. The method of claim 8, wherein performing heuristic methods to determine the veracity of the selected attribute comprises:
comparing profile information of users in the cluster and their connections in the social networking system, and
determining a lack of the selected attribute in a particular user based on an irregularity in the compared profile information.

11. The method of claim 1, wherein determining an accuracy measurement of the cluster based upon the verifying comprises:
calculating a percentage of the cluster that has been verified as sharing the selected attribute, and
determining the accuracy measurement of the cluster as the calculated percentage.

12. The method of claim 1, wherein determining an accuracy measurement of the cluster based upon the verifying comprises:
determining predictive factors that indicate the veracity of the selected attribute, each predictive factor having a predictive value;
determining coefficients for each predictive factor based on the verifying of users related to the cluster; and
determining the accuracy measurement by performing a regression analysis on the cluster based on the determined coefficients and predictive values.

13. The method of claim 1, further comprising:
responsive to the accuracy measurement not meeting a predetermined threshold, refining the cluster to remove false positives from the subset of users sharing the selected attribute.

14. The method of claim 13, wherein refining the cluster to remove false positives from the subset of users sharing the selected attribute comprises removing users from the cluster based on profile information indicating a lack of the selected attribute.

15. The method of claim 13, wherein refining the cluster to remove false positives from the subset of users sharing the selected attribute comprises removing users from the cluster based on an inference indicating a lack of the selected attribute.

16. The method of claim 1, wherein the subset of users sharing the selected attribute comprises users of the social networking system that have recently used a specified application on the social networking system.

17. The method of claim 1, wherein the subset of users sharing the selected attribute comprises users of the social networking system that regularly share content information with other users on the social networking system.

18. The method of claim 1, wherein the subset of users sharing the selected attribute comprises users that use the social networking system heavily.

19. The method of claim 1, wherein the subset of users sharing the selected attribute comprises users of the social networking system whose profile information has recently changed.

20. The method of claim 1, wherein the subset of users sharing the selected attribute comprises sub-clusters of users, each sub-cluster comprising users that share a predefined attribute.

21. A method for defining clusters based on a behavioral attribute of users of a social networking system, the method comprising:
receiving a selection of the behavioral attribute shared by a subset of users of a social networking system;
defining a cluster as the subset of users sharing the selected behavioral attribute;
authenticating users of the social networking system related to the cluster;
determining an accuracy measurement of the cluster based upon the authenticating; and
providing the cluster and the accuracy measurement for performance based testing.

22. The method of claim 21, wherein the behavioral attribute comprises recommending a content item to connections of the user.

23. The method of claim 21, wherein the behavioral attribute comprises using an application on the social networking system.
